(19) United States
(12) Patent Application Publication
(10) Pub. No.: US 2023/0253197 A1
(43) Pub. Date: Aug. 10, 2023

(54) MASS SPECTROMETRY METHOD AND MASS SPECTROMETER

(71) Applicant: SHIMADZU CORPORATION, Kyoto-shi, Kyoto (JP)

(72) Inventors: Yoshiharu YAMADA, Kyoto-shi (JP); Daisuke OKUMURA, Kyoto-shi (JP)

(73) Assignee: SHIMADZU CORPORATION, Kyoto-shi, Kyoto (JP)

(21) Appl. No.: 18/015,649

(22) PCT Filed: Sep. 4, 2020
(86) PCT No.: PCT/JP2020/033694

§ 371 Date: Jan. 11, 2023

(51) Int. Cl. H01J 49/06; G01N 27/623; G01N 30/72

(52) U.S. Cl. CPC H01J 49/067; G01N 27/623; G01N 30/7206

(57) ABSTRACT

A mass spectrometer includes: a storage unit 411 which stores, for an ion having a predetermined mass-to-charge ratio, a reference value which is a value lower than a maximum value of a measured intensity of the ion, the maximum value being obtained by optimizing a measurement parameter of each unit; and a parameter adjustment unit 43 configured to adjust a measurement parameter of each unit such that a measured intensity of the ion having the predetermined mass-to-charge ratio equals the reference value when a sample containing the ion is measured.

### TECHNICAL FIELD

The present invention relates to a mass spectrometer and a mass spectrometry method.

### BACKGROUND ART

A chromatograph mass spectrometer is used to quantify target components in a sample. In the chromatograph mass spectrometer, a target component contained in a sample is separated from other components by a column of a chromatograph and introduced into a mass spectrometer. The mass spectrometer ionizes the introduced component, measures the ions having a mass-to-charge ratio characteristic of the target component, and quantifies the target component on the basis of the intensity.

In quantifying the target component, measurement parameters of the mass spectrometer are adjusted before measurement of the sample to be analyzed. The mass spectrometer includes units such as an ionization unit, an ion transport optical system, a mass separation unit, and an ion detection unit, and there is a measurement parameter, such as the magnitude of a voltage applied to an electrode, for each unit. Patent Literature 1 describes that such measurement parameters are automatically tuned (autotuning). In autotuning, a standard sample containing a standard substance is introduced into a mass spectrometer, and the intensity of a predetermined ion generated from the standard substance is measured under a plurality of conditions in which measurement parameters of each unit are different. Then, the measurement parameters of each unit are tuned so that the measured intensity of the ion becomes the highest.

After the autotuning is performed, a plurality of standard samples each containing the target component at different known concentrations are subjected to mass spectrometry, and a calibration curve representing the relationship between the measured intensity of the predetermined ion derived from the target component and the content of the target component is created. Then, the sample to be analyzed is subjected to mass spectrometry, and the measured intensity of the ion is collated with the calibration curve to quantify the target component contained in the sample.

### CITATION LIST

### Patent Literature

Patent Literature 1: JP 2018-120804 A

### SUMMARY OF INVENTION

### Technical Problem

When the mass spectrometer is used for a long period of time, constituent parts such as an electrode of each unit deteriorate over time. When the electrode or the like deteriorates over time, even if the same voltage is applied to the electrode or the like using the same measurement parameters as those before the deterioration over time, the electric field for controlling the behavior of ions is different from that before the deterioration over time, and the accuracy of measurement is reduced. As a result, ions cannot be measured with the same accuracy and sensitivity as when autotuning was performed in the past.

When a large number of samples are subjected to mass spectrometry, several mass spectrometers may be used. In such a case, mass spectrometers of the same model are usually used. However, even in the mass spectrometers of the same model, dimensions and assembly accuracy of constituent parts of the mass spectrometers are different within a tolerance range. Therefore, even if the same voltage is applied to electrodes or the like using the same measurement parameter in all the mass spectrometers, the electric field generated for each mass spectrometer may differ, and ions cannot be measured with the same accuracy and sensitivity.

These problems can be solved by creating an individual calibration curve for each sample analysis and each mass spectrometer. However, in order to create a calibration curve for each analysis and each mass spectrometer, it is necessary to prepare a plurality of standard samples containing a target component at different known concentrations each time and measure each of the standard samples, which takes time and labor.

An object of the present invention is to provide a technique capable of easily and accurately performing mass spectrometry regardless of deterioration over time of a mass spectrometers or a machine difference between mass spectrometers.

### Solution to Problem

A mass spectrometer according to the present invention made to solve the above problems includes:

a storage unit which stores, for an ion having a predetermined mass-to-charge ratio, a reference value which is a value lower than a maximum value of a measured intensity of the ion, the maximum value being obtained by optimizing a measurement parameter of each unit of the mass spectrometer; and

a parameter adjustment unit configured to adjust the measurement parameter of each unit such that a measured intensity of the ion having the predetermined mass-to-charge ratio equals the reference value when a sample containing the ion is measured.

A mass spectrometry method according to the present invention made to solve the above problems includes, when mass spectrometry is performed on an ion having a predetermined mass-to-charge ratio by using a mass spectrometer, adjusting a measurement parameter of each unit of the mass spectrometer such that the ion is detected with a predetermined reference value which is a value lower than a maximum value of a measured intensity of the ion, the maximum value being obtained by optimizing the measurement parameter of each unit.

### Advantageous Effects of Invention

In the mass spectrometer and the mass spectrometry method according to the present invention, for a predetermined ion, a reference value which is a value lower than the maximum value of the measured intensity of the ion is stored in a storage unit in advance, where the maximum value is obtained by optimizing a measurement parameter of each unit. Then, the measurement parameter of each unit is adjusted such that a measured intensity of an ion having a predetermined mass-to-charge ratio equals the reference value. A conventional mass spectrometer adjusts measurement parameters such that a measured intensity of the predetermined ion reaches the maximum value. Therefore, when the mass spectrometer deteriorates over time, it is impossible to measure the ion with the maximum value. The mass spectrometer and the mass spectrometry method according to the present invention can accurately perform mass spectrometry without creating a calibration curve for each analysis by using, as the reference value, an intensity value of an ion that can be reached even when deterioration occurs over time. Even when there is a machine difference between mass spectrometers, by setting the reference value of the measured intensity of the ion that can be acquired by all the mass spectrometers to be used, all the mass spectrometers can perform accurate mass spectrometry without creating a calibration curve for each mass spectrometer.

### BRIEF DESCRIPTION OF DRAWINGS

FIG. 1 is a configuration diagram of a main part of an embodiment of a mass spectrometer according to the present invention.

FIG. 2 is a flowchart of a mass spectrometry method according to the present invention.

FIG. 3 is a graph showing changes in the measured intensity of an ion with respect to values of voltages applied to a third ion lens arranged at an inlet of a collision cell.

FIG. 4 is a graph showing changes in the measured intensity of the ion with respect to values of voltages applied to a first ion lens arranged at the inlet of the collision cell.

FIG. 5 is a graph showing changes in the measured intensity of the ion with respect to values of voltages applied to a second ion guide.

### DESCRIPTION OF EMBODIMENTS

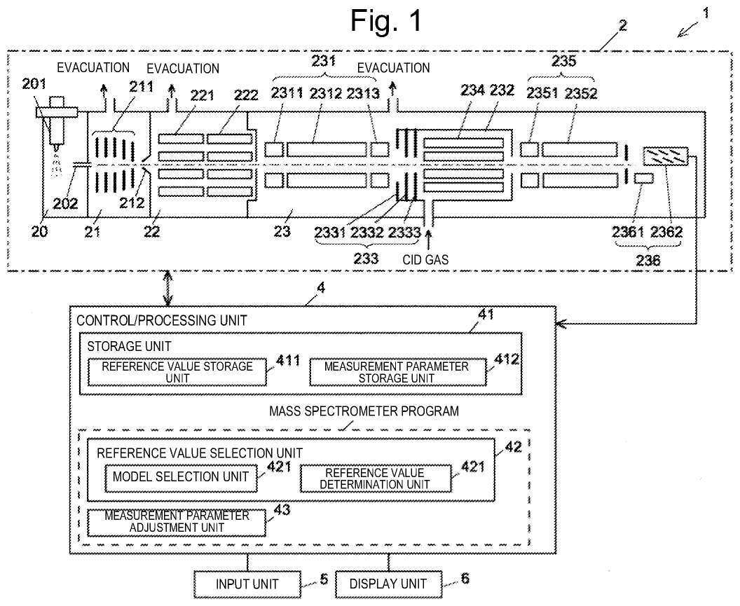

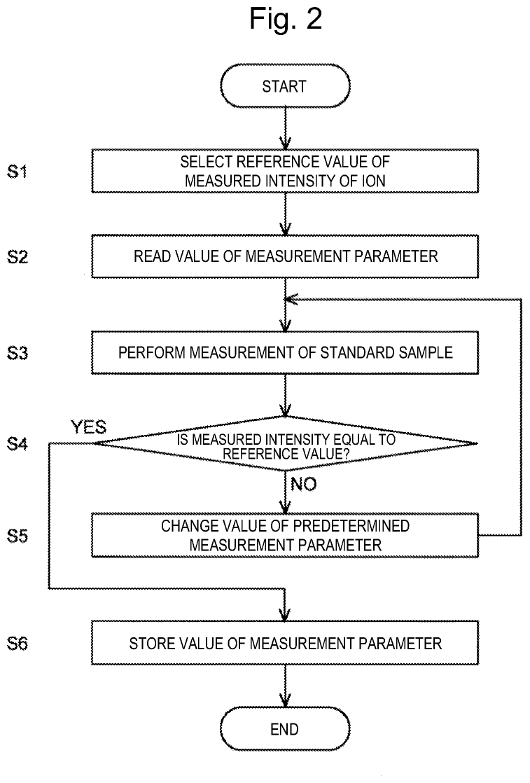

An embodiment of a mass spectrometer according to the present invention will be described below with reference to the drawings. FIG. 1 is a configuration diagram of a main part of a triple quadrupole mass spectrometer (hereinafter, also simply referred to as “mass spectrometer”) 1 which is an embodiment of the mass spectrometer according to the present invention. In the present embodiment, a triple quadrupole mass spectrometer (triple quadrupole mass spectrometer) will be described, but the present invention can also be applied to a mass spectrometer having another configuration (a single quadrupole mass spectrometer, an ion trap mass spectrometer, a quadrupole-time-of-flight mass spectrometer, or the like).

A mass spectrometer 1 of the present embodiment roughly includes a mass spectrometer unit 2, and a control/processing unit 4 that controls operations of units constituting the mass spectrometer unit 2.

The mass spectrometer unit 2 includes an ionization chamber 20, a first intermediate vacuum chamber 21, a second intermediate vacuum chamber 22, and an analysis chamber 23. Each of these chambers is provided in a vacuum chamber. The ionization chamber 20 is at substantially atmospheric pressure. The first intermediate vacuum chamber 21 is a low vacuum chamber evacuated by a rotary pump (not illustrated). The second intermediate vacuum chamber 22 and the analysis chamber 23 are high vacuum chambers evacuated by a turbo molecular pump. The first intermediate vacuum chamber 21, the second intermediate vacuum chamber 22, and the analysis chamber 23 have a configuration of a multistage operation evacuation system in which the degree of vacuum increases stepwise in this order.

The ionization chamber 20 is provided with an electrospray ionization probe (ESI probe) 201 for nebulizing sample solution while imparting electric charges to the sample solution. The ionization chamber 20 and the first intermediate vacuum chamber 21 communicate with each other through a thin heated capillary 202.

In the first intermediate vacuum chamber 21, a first ion lens group 211 including a plurality of annular electrodes that transport ions to the subsequent stage while converging the ions is arranged. The first intermediate vacuum chamber 21 and the second intermediate vacuum chamber 22 are separated from each other by a skimmer 212 having a small hole at its top.

In the second intermediate vacuum chamber 22, a first ion guide 221 and a second ion guide 222 are disposed. Each of the first ion guide 221 and the second ion guide 222 transports the ions to the subsequent stage while converging the ions, and includes a plurality of electrodes. The second intermediate vacuum chamber 22 and the analysis chamber 23 communicate with each other through a small hole formed in a partition wall.

In the analysis chamber 23, a front quadrupole mass filter (Q1) 231, a collision cell 232, a rear quadrupole mass filter (Q3) 235, and an ion detector 236 are installed. The front quadrupole mass filter 231 includes a pre-rod electrode 2311, a main rod electrode 2312, and a post-rod electrode 2313. A second ion lens group 233 is arranged at an inlet of the collision cell 232, and a multipole mass filter (q2) 234 is arranged at the subsequent stage of the collision cell 232. The second ion lens group 233 includes a first ion lens 2331, a second ion lens 2332, and a third ion lens 2333, all of which are ring-shaped electrodes, and converges ions that have entered the collision cell 232 and introduces the ions into the multipole mass filter 234. The collision cell 232 is provided with a gas inlet for introducing a collision-induced dissociation gas (CID gas) such as argon gas or nitrogen gas. The rear quadrupole mass filter 235 includes a pre-rod electrode 2351 and a main rod electrode 2352. The ion detector 236 includes a conversion dynode 2361 that generates electrons by allowing ions to enter and a secondary electron multiplier tube 2362 that multiplies the electrons generated in the conversion dynode 2361.

The mass spectrometer unit 2 can perform various measurements, such as a selected ion monitoring (SIM) measurement, an MS/MS scan measurement (product ion scan measurement), and a multiple reaction monitoring (MRM) measurement. In the SIM measurement, the front quadrupole mass filter (Q1) 231 does not select ions (i.e., does not function as a mass filter), and the mass-to-charge ratio of ions to be allowed to pass through the rear quadrupole mass filter (Q3) 235 is fixed for ion detection.

On the other hand, in the MS/MS scan measurement and the MRM measurement, both the front quadrupole mass filter (Q1) 231 and the rear quadrupole mass filter (Q3) 235 function as the mass filters. The front quadrupole mass filter (Q1) 231 passes only the ions having the mass-to-charge ratio set as precursor ions. A CID gas is supplied into the collision cell 232 to fragment the precursor ion into product ions. In the MS/MS scan measurement, the product ions are detected while the mass-to-charge ratio of the ions passing through the rear quadrupole mass filter (Q3) 235 is scanned. In the MRM measurement, the product ions are detected while the mass-to-charge ratio of the ions passing through the rear quadrupole mass filter (Q3) 235 is fixed.

The control/processing unit 4 includes a reference value selection unit 42 and a measurement parameter adjustment unit 43 as functional blocks in addition to a storage unit 41. The reference value selection unit 42 includes a model selection unit 421 and a reference value determination unit 422. The control/processing unit 4 is actually a personal computer including a processor that functions as the units described above when a mass spectrometer program preinstalled on the computer is executed. An input unit 5 and a display unit 6 are connected to the control/processing unit 4.

The storage unit 41 is provided with a reference value storage unit 411 and a measurement parameter storage unit 412. The reference value storage unit 411 stores, for a predetermined ion, a reference value of the measured intensity of the ion, which is a value lower than the maximum value of the measured intensity obtained in a state where all the measurement parameters of the mass spectrometer are optimized. This reference value is set not only for the model of the mass spectrometer 1 of the present embodiment but also for models of other mass spectrometers, and the model name and the reference value of the measured intensity of the ion are stored in association in the reference value storage unit 411. The predetermined ion is, for example, an ion generated from a substance contained in a standard sample used for mass calibration or the like. The standard sample is provided from, for example, a manufacturer of the mass spectrometer. Alternatively, a standard sample prepared by a user of the mass spectrometer may be used. When the mass spectrometer is used for detecting or quantifying a specific target component, it is preferable to use a standard sample containing a standard substance that generates ions of the same type as, similar to, or having the same mass-to-charge ratio as the ions generated from the component.

The reference value of the measured intensity of an ion stored in the reference value storage unit 411 can be determined in advance as follows.

The mass spectrometer 1 of the present embodiment includes the first ion lens group 211, the first ion guide 221, the second ion guide 222, the front quadrupole mass filter 231, the second ion lens group 233, the multipole mass filter 234, the rear quadrupole mass filter 235, and the ion detector 236 in order to transport or measure ions.

For example, assuming that each of these eight constituent elements has an ion passing efficiency of 90% on average, about 43% of ions on average permeate through the entire mass spectrometer 1. Considering that each constituent element has a machine difference, the standard deviation a of the variation in ion passing efficiency of each constituent element is set to 0.033333 (the difference from the average 0.9 is approximated to 3σ with about I as the maximum value), and the variance is set to 0.001111, which is the square of the standard deviation. Then, the variance of the entire mass spectrometer 1 is 0.008889 (variance of each part x number of constituent elements), and the standard deviation a (square root of variance) is 0.094281.

Here, if the maximum value in the range of the variation in ion passing efficiency due to the machine difference is the average value+3σ and the minimum value is the average value−3σ, the former is 71% and the latter is 15%. That is, even in the same type of model, there is a machine difference in ion passing efficiency within the range of 15 to 71%. Therefore, when a coefficient of 15%/71%≈0.2 is set, mass spectrometry can be performed with the same sensitivity regardless of the machine difference. That is, when 20% of the measured intensity of a predetermined ion obtained in a state where all the parameters of the mass spectrometer unit 2 are optimized is set as the reference value, the measured intensity of the ion using a mass spectrometer having the maximum ion passing efficiency (71%) within the machine difference range can be matched with the measured intensity of the ion using a mass spectrometer having the minimum ion passing efficiency (15%) within the machine difference range.

The above is an example assuming the most extreme case, and for example, a coefficient of 15%/43%≈0.35 may be set based on the average ion passing efficiency as reference. Alternatively, an appropriate value within a range of 0.2 to 0.35 may be set as the coefficient. Each of the numerical values mentioned here is an example of determining the reference value of the measured intensity of ions, and an appropriate reference value can be set according to the mass spectrometer to be actually used in consideration of the type of the mass spectrometer, the number of constituent elements, a machine difference, and the like. For example, for each of the plurality of mass spectrometers, the measured intensities of predetermined ions obtained when the values of all the parameters are optimized are actually measured, and the smallest measured intensity of ions can be set as the reference value common to all the mass spectrometers.

The measurement parameter storage unit 412 stores values of measurement parameters used when mass spectrometry is performed. The values of the measurement parameters are collectively stored for each constituent elements of an ESI probe 201, the first ion lens group 211, the first ion guide 221, the second ion guide 222, the front quadrupole mass filter 231, the collision cell 232, the rear quadrupole mass filter 235, and the ion detector 236. Regarding the measurement parameters of each unit, the types of measurement parameters whose values should be changed at the time of adjustment of the measurement parameters to be described later are also stored. In the mass spectrometer 1 of the present embodiment, the value of the voltage applied to the third ion lens 2333 in the second ion lens group 233 provided at the inlet of the collision cell 232 is registered as the adjustment target.

When the mass spectrometer is used for the first time, initial values of measurement parameters of each unit are stored. As the initial values of the measurement parameters, for example, values optimized so that the measured intensity of ions becomes the highest at the time of shipment of the mass spectrometer are stored. In a case where adjustment work of the measurement parameters described later has been performed in the past, the measurement parameter storage unit 412 stores the most recently adjusted measurement parameter values in association with each reference value.

The measurement parameters in the mass spectrometer 1 of the present embodiment will be described.

The measurement parameters related to the ESI probe 201 include, for example, a direct-current (DC) voltage (ESI voltage) applied to the ESI probe 201, a gas temperature and a gas flow rate of a nebulizer gas, a tip position of the ESI probe 201 (position with respect to the inlet of the heated capillary 202), and a heating temperature of the heated capillary 202.

The measurement parameters related to the first ion lens group 211 include, for example, the magnitude of a DC voltage and the amplitude and frequency of a radio-frequency voltage applied to each annular electrode, and the position of each electrode.

The measurement parameters related to the first ion guide 221 and the second ion guide 222 include, for example, the magnitude of a DC voltage and the amplitude and frequency of a radio-frequency voltage applied to each rod-shaped electrode, and the position of each electrode.

The measurement parameters of the front quadrupole mass filter 231 include, for example, the magnitude of the DC voltage and the amplitude and frequency of a radio-frequency voltage applied to each of the pre-rod electrode 2311, the main rod electrode 2312, and the post-rod electrode 2313, and the position of each electrode.

The measurement parameters of the collision cell 232 include, for example, the magnitude of a DC voltage and the amplitude and frequency of a radio-frequency voltage applied to each ion lens constituting the second ion lens group 233. The measurement parameters of the collision cell 232 also include the pressure of a collision gas, the magnitude of a DC voltage and the amplitude and frequency of a radio-frequency voltage applied to the multipole mass filter 234 disposed in the collision cell 232, and a DC voltage applied to each of the inlet and an outlet of the collision cell 232.

The measurement parameters of the rear quadrupole mass filter 235 include, for example, the magnitude of a DC voltage and the amplitude and frequency of a radio-frequency voltage applied to each of the pre-rod electrode 2351 and the main rod electrode 2352, and the positions of the pre-rod electrode 2351 and the main rod electrode 2352.

The measurement parameters of the ion detector 236 include the positions of the conversion dynode 2361 and the secondary electron multiplier tube 2362 and the multiplication factor in the secondary electron multiplier tube 2362.

The mass spectrometer of the present embodiment is characterized by tuning of measurement parameters (autotuning) performed before actually performing mass spectrometry of a sample to be analyzed.

When the mass spectrometer is used for a long period of time, constituent parts such as an electrode of each unit deteriorate over time. When the electrode or the like deteriorates over time, even if the same voltage is applied to the electrode or the like using the same measurement parameters as those before the deterioration over time, the electric field for controlling the behavior of ions is different from that before the deterioration over time, and the accuracy of measurement is reduced. As a result, ions cannot be measured with the same accuracy and sensitivity as when autotuning was performed in the past.

A plurality of mass spectrometers may be used in combination to perform mass spectrometry on a large number of samples. In such a case, mass spectrometers of the same model are usually used. However, even in the mass spectrometers of the same model, dimensions and assembly accuracy of constituent parts of the mass spectrometers are different within a tolerance range. Therefore, even if the same voltage is applied to electrodes or the like using the same measurement parameter in all the mass spectrometers, the electric field generated for each mass spectrometer may differ, and ions cannot be measured with the same accuracy and sensitivity. It is a matter of course that the accuracy and sensitivity of the mass spectrometry are different when the model of the mass spectrometer is different.

The mass spectrometer 1 of the present embodiment, in any of the above cases, adjusts measurement parameters such that ions generated from the same amount of the target component are always measured with the same intensity in all the mass spectrometers. Adjustment of measurement parameters in the mass spectrometer of the present embodiment will be described below.

When a user instructs adjustment of measurement parameters, the model selection unit 421 reads a plurality of sets of the reference value of the measured intensity of a predetermined ion and the model name of a mass spectrometer stored in the reference value storage unit 411, and displays the reference values and/or the model names on the display unit 6.

The user selects one of the plurality of reference values or a model name of mass spectrometers displayed on the display unit 6 (step 1). For example, when the user subjects a sample to be measured to mass spectrometry using only the mass spectrometer operated by the user, or when the user subjects the sample to be measured to mass spectrometry using, in combination, only a mass spectrometer of the same model as the mass spectrometer operated by the user, the user selects the model or the reference value associated with the model. On the other hand, when the user subjects a sample to be measured to mass spectrometry using a mass spectrometer of another model in combination, the user selects a model having the lowest grade among models to be used or a reference value associated with the model. When the user selects a model (or a reference value), the reference value determination unit 422 determines the reference value associated with the selected model (or the selected reference value) as the reference value used for tuning the measurement parameters.

When the reference value to be used for adjustment of the measurement parameters is determined, the measurement parameter adjustment unit 43 reads the values of the measurement parameters of each unit stored in the measurement parameter storage unit 412 (step 2). Then, the measurement parameter adjustment unit 43 displays, on the display unit 6, a screen for prompting the user to set the standard sample.

When the user sets the standard sample and gives an instruction to start measurement, the measurement parameter adjustment unit 43 performs mass spectrometry of the standard sample using the values of the measurement parameters read from the measurement parameter storage unit 412 (step 3), and measures the intensity of a predetermined ion associated with the reference value of the measured intensity.

When the measurement of the standard sample is completed, the measurement parameter adjustment unit 43 determines whether the measured intensity of the predetermined ion is equal to the reference value (the difference between the measured intensity of the ion and the reference value falls within a predetermined allowable range) (step 4).

As described above, at the start of use of the mass spectrometer 1, the values of the measurement parameters optimized so that the measured intensity of the ion becomes the highest is stored. Therefore, usually, the intensity of the predetermined ion measured at this time point is greater than the reference value (NO in step 4). The mass spectrometer 1 of the present embodiment adjusts the measurement parameters so that the measured value of the intensity of the ion is intentionally lowered, that is, a part of the measurement parameters is intentionally deviated from the optimum value.

The measurement parameter adjustment unit 43 reads the type of the measurement parameter to be the subjected to adjustment from the measurement parameter storage unit 412. As described above, in the mass spectrometer 1 of the present embodiment, the value of the voltage applied to the third ion lens 2333 in the second ion lens group 233 provided at the inlet of the collision cell 232 is registered as the adjustment target. Thus, the measurement parameter adjustment unit 43 sets a new measurement parameter in which the value of the applied voltage is changed by a predetermined magnitude from the value of the applied voltage used in the previous measurement (that is, the optimum value adjusted so that the measured intensity of the ion becomes maximum) (step 5). Then, the standard sample is measured again using the newly set measurement parameter (step 3), and the intensity of the predetermined ion is measured.

In the measurement performed after changing the value of the measurement parameter, w % ben the intensity of the ion equals the reference value (YES in step 4), the adjustment of the values of the measurement parameters is ended.

On the other hand, when the intensity of the ion is not equal to the reference value (the measured intensity of the ions is still greater than the reference value, and the difference is within a predetermined allowable range) (NO in step 4), the measurement parameter adjustment unit 43 sets again a new measurement parameter in which the value of the applied voltage is changed by a predetermined magnitude from the value of the applied voltage used in the previous measurement (step 5). Then, the standard sample is measured again using the newly set measurement parameter (step 3), and the intensity of the predetermined ion is measured. In this manner, the change of the value of the measurement parameter and the measurement of the intensity of the predetermined ion are repeated until the measured intensity of the predetermined ion equals the reference value.

When the measured intensity value of the predetermined ion is equal to the reference value (YES in Step 4), the measurement parameter adjustment unit 43 stores (updates) the value of the measurement parameter associated with the reference value of the measured intensity of the ion in the measurement parameter storage unit 412 (Step 6).

As described above, the mass spectrometer of the present embodiment adjusts the measured intensity value of an ion by the voltage applied to the third ion lens 2333 in the second ion lens group 233 provided at the inlet of the collision cell 232. Hereinafter, the reason for the above will be described.

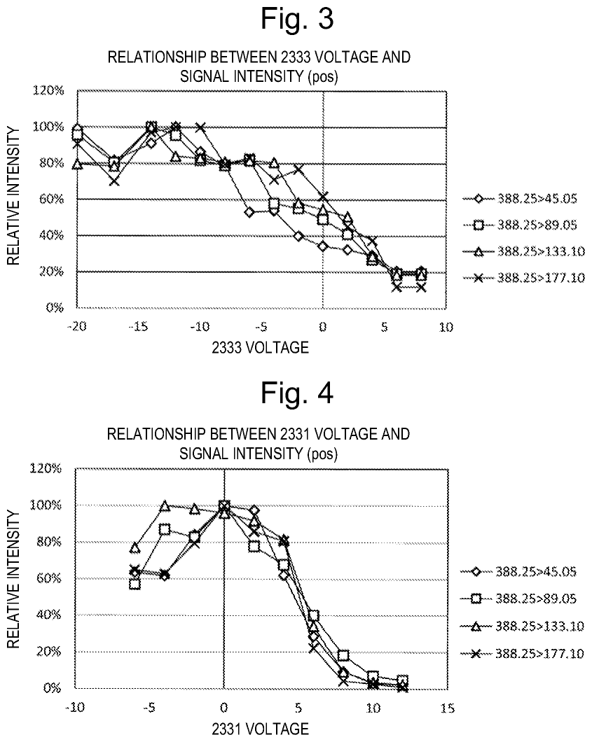

FIG. 3 shows the relationship between the voltage applied to the third ion lens 2333 and the measured intensity of an ion. Notations such as 388.25>45.05 in FIG. 3 indicate the intensity of a product ion in MRM measurement in which an ion having a mass-to-charge ratio of +388.25 is selected as a precursor ion and an ion having a mass-to-charge ratio of +45.05 is selected as the product ion from among ions generated by cleavage of the precursor ion. FIG. 3 illustrates changes in the measured intensity of the product ion when the voltage applied to the third ion lens 2333 is changed for each of four different MRM transitions. As can be seen from the results shown in FIG. 3, the relationship between the magnitude of the applied voltage and the measured intensity of the ion is substantially the same regardless of the type of MRM transition. It can be seen that the measured intensity of the ion can be adjusted in a wide range of less than 20% to 100% by changing the applied voltage. The change in the measured intensity of the ion with respect to the change in the applied voltage is also gentle. Based on these, in this embodiment, the measured intensity value of the ion was adjusted by the voltage applied to the third ion lens 2333.

The relationship between the voltage applied to the constituent elements other than the third ion lens 2333 and the measured intensity of the ion will be described using the first ion lens 2331 and the second ion guide 222 as an example. FIG. 4 shows the relationship between the voltage applied to the first ion lens 2331 and the measured intensity of the ion. The notation in FIG. 4 and the measured MRM transition are the same as those in FIG. 3. From the results shown in FIG. 4, it can be seen that the relationship between the magnitude of the applied voltage and the measured intensity of the ion is almost the same regardless of the type of MRM transition, and the measured intensity of the ion can be adjusted in a wide range by changing the voltage applied to the first ion lens 2331. However, since the change in the measured intensity of the ion with respect to the change in the voltage applied to the first ion lens 2331 is large, it is difficult to adjust the measured intensity of the ion by changing the voltage applied to the first ion lens 2331 as compared with the voltage applied to the third ion lens 2333.

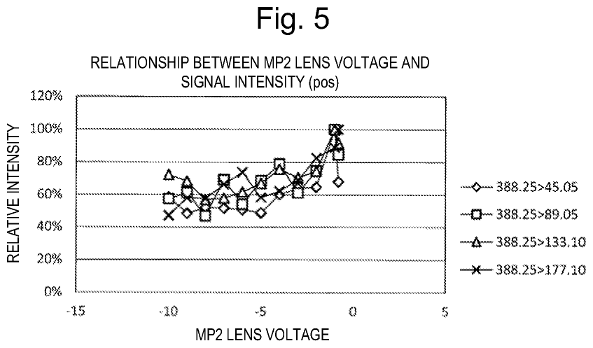

FIG. 5 shows the relationship between the voltage applied to the second ion guide 222 and the measured intensity of the ion. The notation in FIG. 5 and the measured MRM transition are the same as those in FIGS. 3 and 4. As can be seen from the results shown in FIG. 5, the relationship between the magnitude of the applied voltage and the measured intensity of the ion is substantially the same regardless of the type of MRM transition. However, the range of the measured intensity of the ion that can be adjusted by changing the voltage applied to the second ion guide 222 is narrow. Therefore, when the reference value of the measured intensity of the ion is small, the measured intensity of the ion cannot be adjusted only by the voltage applied to the second ion guide 222.

As described above, the adjustment of the measured intensity value of an ion in this embodiment is intended to make the measurement sensitivity of the ion constant regardless of the mass spectrometer and the time of analysis, and it is not preferable that this tuning has different effects on ions having different mass-to-charge ratios. It is also not preferable that the measured intensity of an ion greatly changes only by slightly changing a parameter value.

For example, measurement parameters such as the position of the ESI probe 201, the supply amount and temperature of the nebulizer gas, and the applied voltage need to be optimized according to the characteristics of the sample to be measured and the target component, and thus are not preferable to be subjected to the adjustment for the measured intensity of an ion. For example, the amplification factor by the secondary electron multiplier tube 2362 of the ion detector 236 almost uniformly changes the measured intensity of an ion regardless of the mass-to-charge ratio, but the change in the measured intensity of the ion due to the change in the multiplication factor is large, and it is difficult to set the measured intensity of the ion equal to the reference value. For this reason, in the present embodiment, the magnitude of the voltage applied to the third ion lens 2333 in the second ion lens group 233 is changed. Another measurement parameter having characteristics satisfying the above requirements can also be used for the subject of the adjustment. Alternatively, a plurality of measurement parameters may be subjected to adjustment.

The above embodiment is merely an example, and can be appropriately modified in accordance with the spirit of the invention. In the above embodiment, the plurality of reference values are stored in the reference value storage unit 411, and the user selects one of the plurality of reference values. Alternatively, only one reference value may be stored in the reference value storage unit 411, and the reference value may be automatically selected when a measurement parameter is adjusted.

In the above embodiment, autotuning is performed in order to tune only the voltage applied to the third ion lens 2333. However, when the positions of the ESI probe 201, the first ion lens group 211, and the like are adjusted, the user may manually move the target constituent elements. Alternatively, a moving mechanism that moves a target structure may be provided, and autotuning may be executed in the same manner as in the above embodiment.

In the above embodiment, the reference value of one predetermined ion is associated with one model, but the reference values of measured intensities of a plurality of ions having different mass-to-charge ratios and chemical structures may be associated with one model, and the user may select any one predetermined ion. For example, in the case of a mass spectrometer mainly used for quantification of a pesticide contained in a food and quantification of a drug contained in a biological sample, it is also possible to store a measured intensity value of a predetermined ion derived from the pesticide and a measured intensity value of a predetermined ion derived from the drug, and allow a user to select one corresponding to a sample to be measured to be executed after adjustment of a measurement parameter.

[Modes]

It is understood by those skilled in the art that the plurality of exemplary embodiments described above are specific examples of the following modes.

(Clause 1)

A mass spectrometer according to a mode includes:

a storage unit which stores, for an ion having a predetermined mass-to-charge ratio, a reference value which is a value lower than a maximum value of a measured intensity of the ion, the maximum value being obtained by optimizing a measurement parameter of each unit; and

a parameter adjustment unit configured to adjust the measurement parameter of each unit such that a measured intensity of the ion having the predetermined mass-to-charge ratio equals the reference value when a sample containing the ion is measured.

(Clause 6)

A mass spectrometry method according to a mode includes, when mass spectrometry is performed on an ion having a predetermined mass-to-charge ratio by using a mass spectrometer, adjusting a measurement parameter of each unit of the mass spectrometer such that the ion is detected with a predetermined reference value which is a value lower than a maximum value of a measured intensity of the ion, the maximum value being obtained by optimizing the measurement parameter of each unit.

In the mass spectrometer according to clause 1 and the mass spectrometry method according to clause 6, for an ion having a predetermined mass-to-charge ratio, a reference value which is a value lower than the maximum value of the measured intensity of the ion is stored in a storage unit in advance, where the maximum value is obtained by optimizing a measurement parameter of each unit. Then, the measurement parameter of each unit is adjusted such that a measured intensity of a predetermined ion equals the reference value. A conventional mass spectrometer adjusts measurement parameters such that a measured intensity of the predetermined ion reaches the maximum value. Therefore, when the mass spectrometer deteriorates over time, it is impossible to measure the ion with the maximum value. The mass spectrometer according to clause 1 and the mass spectrometry method according to clause 6 may accurately perform mass spectrometry without creating a calibration curve for each analysis by using, as the reference value, an intensity value of an ion that may be reached even when deterioration occurs over time. Even when there is a machine difference between mass spectrometers, by setting the reference value of the measured intensity of the ion that may be acquired by all the mass spectrometers to be used, all the mass spectrometers may perform accurate mass spectrometry without creating a calibration curve for each mass spectrometer.

(Clause 2)

The mass spectrometer according to clause 1 includes, as constituent units, an ionization unit, an ion transport unit, a front mass separation unit, an ion dissociation unit, a rear mass separation unit, and an ion detection unit, and the parameter adjustment unit is configured to adjust a measurement parameter from unit to unit among the constituent units.

The mass spectrometer according to clause 2 can adjust the measured intensity of the ion while suppressing an effect on other constituent units by adjusting the measurement parameter in each one of the constituent units.

(Clause 3)

In the mass spectrometer according to clause 1 or clause 2, the measurement parameter is a value of a direct-current voltage applied to a predetermined electrode.

Among measurement parameters in the mass spectrometer, a radio-frequency voltage applied to an electrode provided in each unit is often designed to converge or separate ions by mass, and changing the magnitude or frequency of the radio-frequency voltage may affect the measurement result of the sample to be analyzed. On the other hand, a direct-current voltage applied to the electrode provided in each unit is mainly designed for acceleration or deceleration of ions, and has low correlation with the mass-to-charge ratio of ions. Therefore, the mass spectrometer according to clause 3 may adjust the measurement parameter such that the measured intensity of the predetermined ion equals the reference value while suppressing an effect on the measurement result of the sample to be analyzed.

(Clause 4)

In the mass spectrometer according to clause 1 to clause 3,

the storage unit stores a plurality of reference values,

the mass spectrometer further includes a reference value selection unit configured to receive selection of one of the plurality of reference values, and

the parameter adjustment unit is configured to adjust a measurement parameter of each unit such that a measured intensity of the ion having the predetermined mass-to-charge ratio equals the reference value received by the reference value selection unit.

(Clause 5)

In the mass spectrometer according to clause 4,

each of the plurality of reference values is associated with a model of a mass spectrometer.

the reference value selection unit includes:

a model selection unit configured to receive selection of a plurality of models of mass spectrometers to be used for measurement; and

a reference value determination unit configured to determine a smallest reference value among reference values of measured intensities of ions associated with the plurality of models received by the model selection unit, and

the parameter adjustment unit is configured to adjust a measurement parameter of each unit such that a measured intensity of the ion having the predetermined mass-to-charge ratio equals the reference value determined by the reference value determination unit.

The mass spectrometer according to clause 4 may adjust a measurement parameter by selecting a desired value from a plurality of reference values. For example, as in the mass spectrometer according to clause 5, in a case where a plurality of mass spectrometers of different models are used to perform mass spectrometry of a sample to be measured, a reference value suitable for a mass spectrometer with the lowest grade (low ion detection sensitivity) may be selected to match the ion detection sensitivity between the mass spectrometers of different models.

### REFERENCE SIGNS LIST

1 . . . Mass Spectrometer
2 . . . Mass Spectrometer Unit
20 . . . Ionization Chamber
201 . . . Electrospray Ionization (ESI) Probe
202 . . . Heated Capillary
21 . . . First Intermediate Vacuum Chamber
211 . . . First Ion Lens Group
212 . . . Skimmer
22 . . . Second Intermediate Vacuum Chamber
221 . . . First Ion Guide
222 . . . Second Ion Guide
23 . . . Analysis Chamber
231 . . . Front Quadrupole Mass Filter
2311 . . . Pre-Rod Electrode
2312 . . . Main Rod Electrode
2313 . . . Post-Rod Electrode
232 . . . Collision Cell
233 . . . Second Ion Lens Group
2331, 2332, 2333 . . . Ion Lens
234 . . . Multipole Mass Filter
235 . . . Rear Quadrupole Mass Filter
2351 . . . Pre-Rod Electrode
2352 . . . Main Rod Electrode
236 . . . Ion Detector
2361 . . . Conversion Dynode
2362 . . . Secondary Electron Multiplier Tube
4 . . . Control/Processing Unit
41 . . . Storage Unit
411 . . . Reference Value Storage Unit
412 . . . Measurement Parameter Storage Unit
42 . . . Reference Value Selection Unit
421 . . . Model Selection Unit
422 . . . Reference Value Determination Unit
43 . . . Measurement Parameter Adjustment Unit
5 . . . Input Unit
6 . . . Display Unit

1. A mass spectrometer comprising:
a storage unit which stores, for an ion having a predetermined mass-to-charge ratio, a reference value which is a value lower than a maximum value of a measured intensity of the ion, the maximum value being obtained by optimizing a measurement parameter of each unit; and
a parameter adjustment unit configured to adjust the measurement parameter of each unit such that a measured intensity of the ion having the predetermined mass-to-charge ratio equals the reference value when a sample containing the ion is measured.

2. The mass spectrometer according to claim 1, comprising, as
constituent units, an ionization unit, an ion transport unit, a front mass separation unit, an
ion dissociation unit, a rear mass separation unit, and an ion detection unit, wherein
the parameter adjustment unit is configured to adjust a measurement parameter from unit to unit among the constituent units.

3. The mass spectrometer according to claim 1, wherein the measurement parameter is a value of a direct-current voltage applied to a predetermined electrode.

4. The mass spectrometer according to claim 1, wherein
the storage unit stores a plurality of reference values,
the mass spectrometer further comprises a reference value selection unit configured to receive selection of one of the plurality of reference values, and the parameter adjustment unit is configured to adjust a measurement parameter of each unit such that a measured intensity of the ion having the predetermined mass-to-charge ratio equals the reference value received by the reference value selection unit.

5. The mass spectrometer according to claim 4 used with one or more different model mass spectrometers, wherein
each of the plurality of reference values is associated with a model of a mass spectrometer,
the reference value selection unit includes:
a model selection unit configured to receive selection of a plurality of models of mass spectrometers to be used for measurement; and
a reference value determination unit configured to determine a smallest reference value among reference values of measured intensities of ions associated with the plurality of models received by the model selection unit, and
the parameter adjustment unit is configured to adjust a measurement parameter of each unit such that a measured intensity of the ion having the predetermined mass-to-charge ratio equals the reference value determined by the reference value determination unit.

6. A mass spectrometry method comprising, when mass spectrometry is performed on an ion having a predetermined mass-to-charge ratio by using a mass spectrometer, adjusting a measurement parameter of each unit of the mass spectrometer such that the ion is detected with a predetermined reference value which is a value lower than a maximum value of a measured intensity of the ion, the maximum value being obtained by optimizing the measurement parameter of each unit.
